(19) United States
(12) Patent Application Publication
(10) Pub. No.: US 2005/0162997 A1
(43) Pub. Date: Jul. 28, 2005

(54) Method and system for controlling disk servo

(76) Inventor: Dug-Hyun Lee, ChungCheongnam-do (KR)

Correspondence Address: Jonathan Y Kang;Lee Hong Degerman Kang & Schmadeka, 14th Floor, 801 South Figueroa Street, Los Angeles, CA, 90017-5554, US

(21) Appl. No.: 10/508,127

(22) PCT Filed: Mar. 12, 2003
(86) PCT No.: PCT/KR03/00479

(30) Foreign Application Priority Data
Mar. 16, 2002 (KR) 10-2002-0014258

(51) Int. Cl. G11B 7/00

(52) U.S. Cl. 369/44.29; 369/47.46; 369/53.3; 369/44.35

(57) ABSTRACT

Disclosed is a system and method for controlling a driving speed of a motor by controlling a gain of a servo according to a predetermined reference corresponding to the external environment. The present invention includes a sensing unit outputting a sensing signal by monitoring at least one selected from the group consisting of an external temperature, a noise, and a remaining battery amount, a main control unit outputting a servo gain information to respond to the sensing signal, and a servo control unit controlling at least one of a revolution speed of a disk and a moving speed of an optical pickup to respond to the servo gain information of the main control unit.

### TECHNICAL FIELD

The present invention relates to a system for controlling a disk servo and a method thereof to cope with external environment including power, noise, temperature, etc., and more particularly, to a system and method for controlling a driving speed of a motor by controlling a gain of a servo according to a predetermined reference corresponding to the external environment.

### BACKGROUND ART

Generally, a disk player including a servo mechanism is controlled by a servo.

FIG. 1 illustrates a block diagram of a disk player including a servo mechanism according to a related art.

Referring to FIG. 1, a spiral record track is formed on a disk, and digital data are recorded in the record track according to a predetermined format. The predetermined format includes CD, VCD, DVD, and the like. For instance, in case of CD, a feet having a predetermined length is formed on the record track corresponding to an EFM signal generated by EFM-modulating the digital data.

A motor 105 represented by a spindle motor revolves the disk at a prescribed speed by a motor driver 110. The motor driver 110 revolves the motor at a prescribed speed to correspond to a motor driving signal 145 supplied from a servo control unit 130.

A pickup device 115 confronts a surface of the record track of the disk, and is installed to be movable in a radial direction of the disk. The pickup device 115 includes a laser light source and a sensor.

An actuator 120 supports the pickup device 115, and corresponds to an actuator driving signal 140 supplied from the servo control unit to move the pickup device 115 in the radial direction of the disk.

An servo error detecting unit 135 enables to generate a tracking error signal, a focusing error signal, and the like.

The servo control unit 130 receives the EFM and tracking error signals and generates the motor driving signal 145 and the actuator driving signal 140.

For instance, when a CLV (constant linear velocity) control is performed, the motor driving signal 145 for driving the motor driver 110 is generated while a frequency of the EFM signal is maintained as a predetermined value.

When a CAV (constant angular velocity) control is performed, the motor driving signal 145 for driving the motor driver 110 is generated while a revolution display signal frequency is maintained as a predetermined value.

Simultaneously, the servo control unit 130 approximates the tracking signal to ‘0’ to generate the actuator driving signal. Through such a process, the servo is controlled.

However, the related art servo control only performs a function of controlling the driving speed of the motor at a predetermined velocity.

Generally, it is preferable that a specific position of the disk is sought as fast as possible (SEEK) and that the servo is controlled to read the data with high speed (READ). Yet, it is not always desirable for all circumstances that the specific position of the disk is sought so fast and that the data is read at high speed.

For instance, when a power of the power source of a portable disk storage device is in short, ‘SEEK’ and ‘READ’ of high speed accelerate power consumption to make the disk player down occasionally.

And, ‘SEEK’ and ‘READ’ of high speed in a quiet place generate unnecessary noises.

Moreover, when a temperature of the disk player is deviated from a room temperature, ‘SEEK’ and ‘READ’ of high speed increase the possibility of causing noises and malfunctions.

### DISCLOSURE OF THE INVENTION

Accordingly, the present invention is directed to method and system for controlling a disk servo that substantially obviate one or more of the problems due to limitations and disadvantages of the related art.

An object of the present invention is to provide method and system for controlling a disk servo enabling to control a speed of a motor and a moving speed of an optical pickup by controlling a gain of the servo according to the external environment.

Another object of the present invention is to provide method and system for controlling a disk servo enabling to prevent an interruption of a disk player as well as drive the disk player longer by controlling a gain of the servo to operate a motor and an actuator with low speed when a power of a power source is insufficient.

A further object of the present invention is to provide method and system for controlling a disk servo enabling to prevent the generation of unnecessary noises by controlling a gain of the servo to drive the motor and actuator with low speed when a disk driving device is operated in a quiet place.

A further object of the present invention is to provide method and system for controlling a disk servo enabling to perform the control by a program previously inputted to a chip set.

A further object of the present invention is to provide method and system for controlling a disk servo enabling a product itself to judge states of noise, power of power source, and the like through a sensor.

Another further object of the present invention is to provide method and system for controlling a disk servo enabling a user to select a servo control state through a user interface.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in a servo control system of a disk player, the servo control system according to the present invention includes a sensing unit outputting a sensing signal by monitoring at least one selected from the group consisting of an external temperature, a noise, and a remaining battery amount, a main control unit outputting a servo gain information to respond to the sensing signal, and a servo control unit controlling at least one of a revolution speed of a disk and a moving speed of an optical pickup to respond to the servo gain information of the main control unit.

Preferably, the servo control system further includes a user interface receiving the servo gain information from a user.

Preferably, the servo control unit includes a revolution speed servo control unit, a feeding servo control unit, a tracking servo control unit or a focusing servo control unit.

More preferably, the main control unit provides the servo control unit with an information for a revolution speed servo gain and wherein servo gain values of the feeding servo control unit, the tracking servo control unit, and the focusing servo control unit are set to correspond to a servo gain value of the revolution speed servo control unit.

More preferably, the main control unit provides the revolution speed servo control unit, the feeding servo control unit, the tracking servo control unit, and the focusing servo control unit with a revolution speed servo gain information, a feeding servo gain information, a tracking servo gain information, and a focusing servo gain information, respectively.

More preferably, the revolution speed of the disk is maintained as it is and the moving speed of the optical pickup is set by low speed if the monitored noise is below a predetermined reference.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a block diagram of a disc player including a servo mechanism according to a related art;

FIG. 2A illustrates a block diagram of an overall structure of a method of controlling a disk servo according to one preferred embodiment of the present invention;

FIG. 2B illustrates a graph of a voltage drop of a battery in accordance with use of the preferred embodiment of the present invention;

FIG. 2C illustrates a graph of dB corresponding to a peripheral noise according to the preferred embodiment of the present invention;

FIG. 3A illustrates a block diagram of an overall structure for controlling a gain of a servo to correspond to peripheral environmental variables according to the preferred embodiment of the present invention;

FIG. 3B illustrates a flowchart of a process for controlling a gain of a servo to correspond to peripheral environmental variables according to the preferred embodiment of the present invention; and

FIG. 4 illustrates a block diagram of a disk player for controlling a servo according to another preferred embodiment of the present invention.

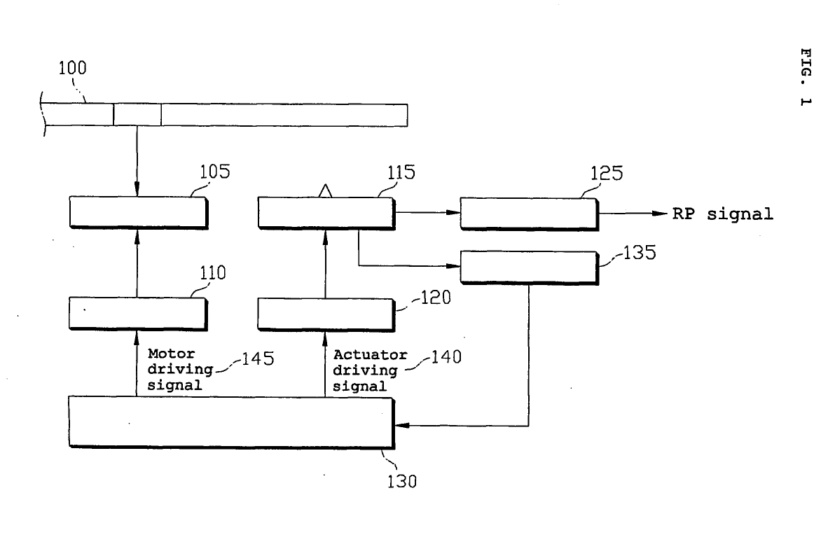

### BEST MODE FOR CARRYING OUT THE INVENTION

Reference will now be made in detail to the preferred embodiments of the present invention, examples of which are illustrated in the accompanying drawings.

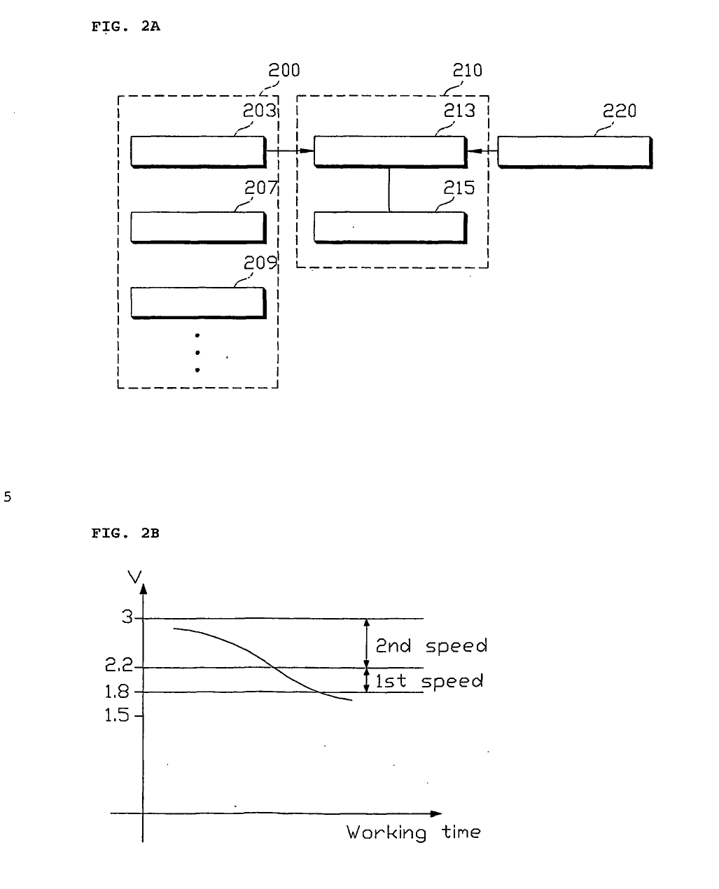

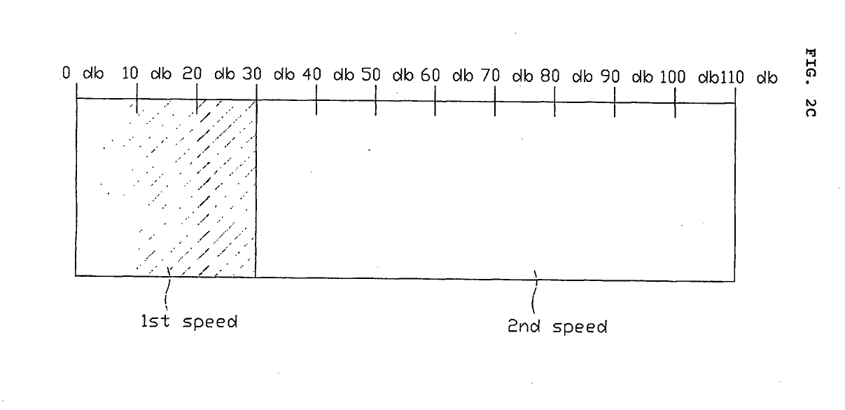

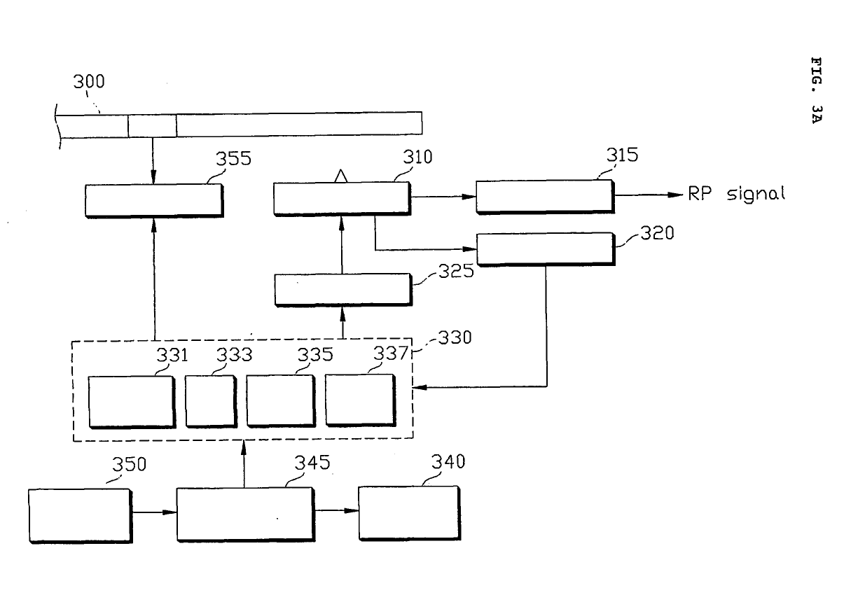

FIG. 2A illustrates a block diagram of an overall structure of a method of controlling a disk servo according to one preferred embodiment of the present invention.

Generally, a disk player uses a term of ‘compact disk access time’ relating to a revolution speed of a motor. The compact disk access time of audio CD is smaller than that of data CD in general. The present invention is explained in the following by taking audio CD as a reference. Yet, it is apparent to those skilled in the art that the present invention is applicable to video CD, DVD, and the like.

In the following description, ‘second speed’ and ‘first speed’ are used as ‘high speed’ and ‘low speed’, respectively.

Referring to FIG. 2A, a servo control apparatus according to one preferred embodiment of the present invention may include a sensing unit 200, a control unit 210, and a user interface 220.

The sensing unit 200 performs a function of measuring variables for peripheral environment. And, the sensing unit 200 of the present invention includes a power source capacity measuring unit 203, a peripheral noise measuring unit 207 or a temperature measuring unit 209, and the like.

The power source capacity measuring unit 203 enables to measure a capacity of a power source uniformly for a real-time or predetermined period. There are many methods of measuring a capacity of a power source, and it is a matter of course that the capacity can be measured by current as well as voltage.

Generally, the disk of the disk player is revolved by the second speed. If a measured voltage is lower than a predetermined voltage, a servo control unit controls a gain to revolve the disk by the first speed.

The peripheral noise measuring unit 207 senses a peripheral noise to transform the sensed noise into an electric signal and then transfers the electric signal to the servo control unit. Generally, the disk of the disk player is revolved by the second speed, and it is preferable that the gain is adjusted to have the disk revolve by the first speed when a measured noise is smaller than a predetermined reference.

The temperature measuring unit 209 measures a temperature of a periphery of the operating disk player to transform the temperature information into an electric signal, and then transfers the electric signal to the servo control unit.

The disk player operates at a temperature range between 0˜40° C. in general. Noises or errors occur in an environment deviated from the temperature range of operation. Preferably, the disk of the disk player is revolved by the second speed at a general room temperature or by the first speed in the environment deviated from the temperature range of operation by adjusting the gain. It is able to reduce the noises or errors in the environment deviated from the room temperature by revolving the disk by the first speed.

The control unit 210 includes a main control unit 213, a servo control unit 215, and the like.

The main control unit 213 sets a servo gain according to a predetermined reference by taking the signal inputted from the sensing unit 200 as a reference. When information about the setup gain is outputted to the servo control unit, the servo control unit 215 revolves the disk according to the inputted gain.

Moreover, the main control unit 210 enables to receive information about a driving speed from a user through the user interface 220 instead of the sensing unit 200.

For instance, when entering such a quiet place as a library, the user can set the disk player to revolve the disk by the first speed previously.

In accordance with the present invention, the servo unit 215 performs controls for a feeding speed, a focusing speed, and a tracking speed as well as a revolution speed of the disk.

A focusing servo control means a control of adjusting the focus of a laser by moving a lens of a pickup device upward and downward. A tracking servo control means a control of moving the lens of the pickup device to track a heat of a recorded signal. And, a feeding servo control means a control of moving the pickup device in a radial direction of a disk.

Specifically, relating to noses or power consumption, the feeding speed may be more significant than the revolution speed of the disk. Namely, a process of moving an optical pickup for searching the disk may bring about more noises or consume more power. Hence, the present invention controls the feeding, focusing, and tracking speeds as well as the revolution speed of the disk according to the peripheral environment.

In accordance with another embodiment of the present invention, the feeding or tracking speed can be adjusted without changing the revolution speed of the disk according to the external environment. As mentioned in the foregoing description, the noise depends on the feeding speed or the like rather than the revolution speed of the disk. In this case, only the feeding and tracking speeds may be adjusted.

For the convenience of understanding the present invention, the first and second speeds has been taken as the example for the explanation. Yet, it is a matter of course that a plurality of speeds such as a third speed, a fourth speed, and the like are designated to achieve the servo control according to the speeds.

The servo control, which is the most significant matter in the present invention, is a revolution speed servo control of controlling a revolution speed of a motor.

The motor revolves the disk, and is generally a spindle motor. The spindle motor is a motor of revolving a platter as a disk. A motor of a floppy disk drive (FDD) revolves 360 (or 300) rpm, but a hard disk uses a high-speed motor of at least 3,600 rpm.

Moreover, CDP revolves only for reading or writing data as FDD does.

RPM (revolution per minute) is a unit for expressing revolutions per minute. As a speed of the spindle motor increases, so does an input/output speed of data relatively. And, a hard disk of a notebook computer may operate with low speed revolutions to reduce power consumption.

The spindle motor of FDD fails to revolve when data of a diskette are not read or written, whereby the disk fails to revolve. On the other hand, a hard disk keeps revolving right after a power of a computer is turned on until the power is turned off.

Since the speeds of FDD for reading/writing data are slow, about 300 rpm of the motor can be immediately reached even if the motor is actuated from a non-operating state, when necessary. Yet, in order for the spindle motor of the non-operating state to reach a normal operating sped of at least 3,600 rpm instantly, the hard disk needs a certain time. Hence, the hard disk continuously revolves for the high-speed operation.

The user interface 220 directly receives information for a driving speed from a user through an interface such as a menu, a button and the like and transmits the information to the control unit 210.

Namely, when the user moves to a public place, a library, or the like, it is able to change the driving speed into the first speed by a predetermined program by having the sensing unit sense a peripheral noise as well as the user may set the driving speed directly through the user interface 220.

FIG. 2B illustrates a graph of a voltage drop of a battery in accordance with use of the preferred embodiment of the present invention.

In case of a general portable CDP, each product has a different power source. For instance, the case of using 3V and 1,500 mA is explained as follows.

In the experiment of taking first and second speeds as first and second compact disk access times, the case of driving the CDP by the second speed only enables to operate for about 10 hours. Yet, when a voltage of the power source is dropped below about 2.2V, the other case of driving the CDP by the first speed enables to operate between 13˜14 hours.

Thus, adjustment of the revolution speed of the CDP according to the remaining amount of the power source enables the CPD to operate for a long time with the limited power source.

Moreover, if the voltage of the power source drops down below 1.8V, the power source fails to drive the CDP. Yet, in this case, if driven by the first speed, the CDP can operate for about 30 minutes more.

FIG. 2C illustrates a graph of dB corresponding to a peripheral noise according to the preferred embodiment of the present invention.

Referring to FIG. 2C, setup references of the first and second speeds according to the degree of a peripheral noise are shown.

A strength of the noise is represented by a unit of dB (decibel). Assuming that the strength of the noise in a soundproof room is ‘0’, a small whisper has about 25 dB. A normal conversation has about 50 dB, and it becomes recognized as ‘noisy’ if the strength exceeds about 70 dB.

Assuming that a noise in a library or the like is about 30 dB, a driving noise of the CDP may have influence on people in a place having the ‘30 dB’ or less. In such a case, it is preferable that the second speed of the revolution speed of the CDP is changed into the first speed by having the sensing unit recognize such a situation or by having the user provide the main control unit with the information for the peripheral noise through the user interface. Moreover, the feeding speed, the tracking speed, and the like as well as the revolution speed can be changed into ‘low speed’.

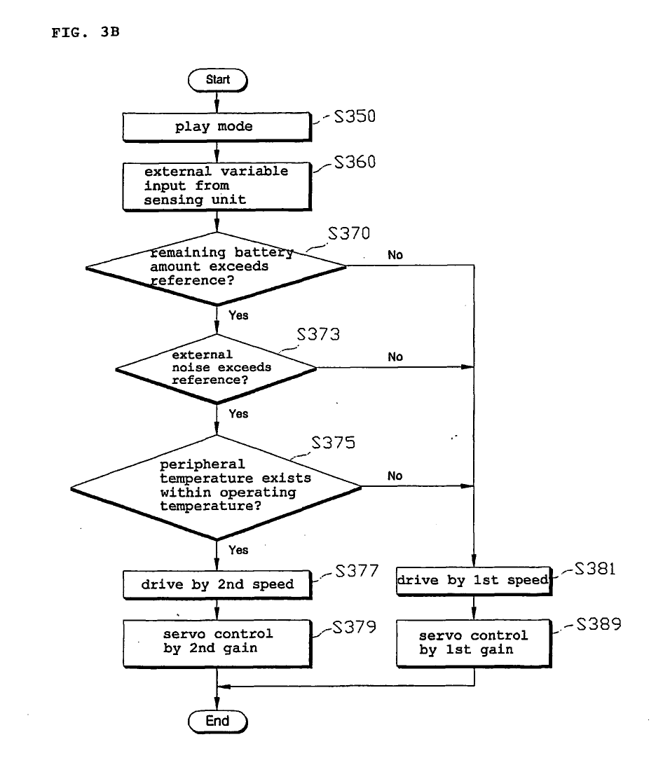

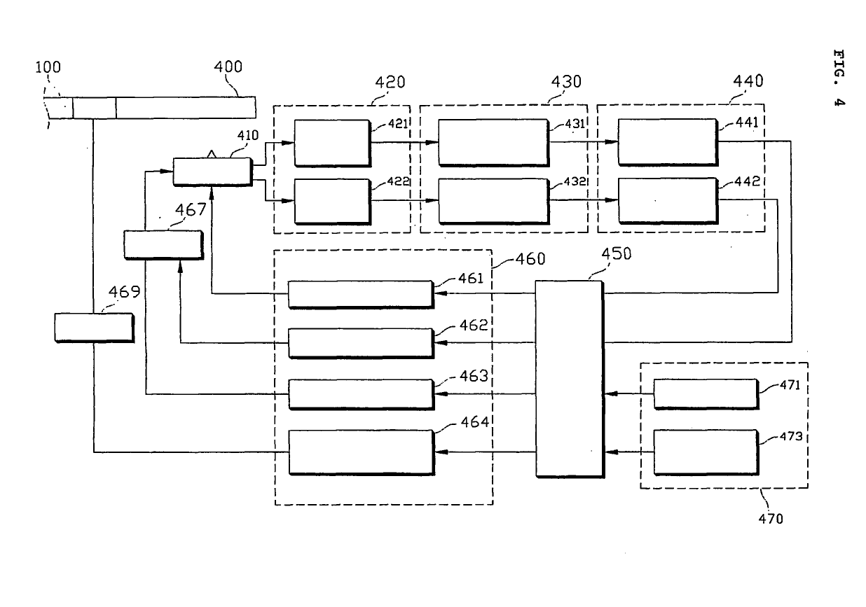

FIG. 3A illustrates a block diagram of an overall structure for controlling a gain of a servo to correspond to peripheral environmental variables according to the preferred embodiment of the present invention.

In the preferred embodiment of the present invention, a revolution speed servo gain is adjusted to correspond to a revolution speed previously set according to a peripheral environment, and a feeding servo gain, a focusing servo gain, and a tracking servo gain are adjusted to correspond to the revolution speed servo gain. As mentioned in the foregoing description, in another embodiment of the present invention, the feeding servo, focusing servo, and tracking servo gains can be controlled regardless of the revolution speed gain.

A servo control according to the present invention is explained by referring to FIG. 3A as follows.

A main control unit 345 enables to receive information for external environmental variables from a sensing unit 350.

The sensing unit 350 carries out a function of measuring variables for a peripheral environment, and the sensing unit 350 according to the present invention may include a power capacity measuring unit, a peripheral noise measuring unit, a temperature measuring unit, and the like.

Currently, it is assumed that a disk player is driven by the second speed. In case that a measurement voltage received through the sensing unit 350 is smaller than a predetermined voltage, that a measurement noise is below a predetermined reference, or that an external measurement temperature is deviated from a predetermined operation temperature, the main control unit 345 may receive information for the revolution speed through a user interface 340.

The main control unit 345 transmits information for a gain value corresponding to the first speed to a servo control unit 330.

The servo control unit 330 includes a revolution speed servo control unit 331, a feeding servo control unit 333, a tracking servo control unit 335, and a focusing servo control unit 337. The revolution speed servo control unit 331 controls a revolution speed of a spindle motor to control a revolution speed of a disk.

There are two types of disk storage media. A CAV (constant angular velocity) type stores information as a form of concentric circle and has a fixed disk revolution speed. A CLV (constant linear velocity) type stores information as a spiral form, and a speed of a central portion is faster than that of a circumference thereof.

In the CAV (constant angular velocity) type, a disk having a concentric circle type track revolves with a constant speed. And, the CAV type is adopted by a hard disk and a floppy disk. As a motor is driven to revolve with the constant speed, the CAV type is more advantageous than the CLV type of which revolution speed should be controlled according to a position of a head. When data are accessed, the head is disposed on a corresponding track and stands by until a corresponding head revolves to be positioned under the head. Hence, the CAV type is advantageous in that the data almost can be accessed immediately. Yet, an outer track of a physically greater area stores the same amount of data of a most inner track, thereby causing storage waste. Namely, in order to keep the revolution speed uniform, the data are stored less densely in the outer track.

The CLV (constant linear velocity) type controls a motor speed according to a head position to make the outer track revolve slower, thereby enabling to compensate the space waste which is the disadvantage of the CAV (constant angular velocity) type. Hence, the speed of reading/writing data becomes constant, whereby each track enables to store the data as many as the physical area without waste. The data are continuously stored along the continuous spiral tracks, and are addressed by ‘minute:second:sector’. The CLV type is suitable for continuous audio or video tracks, while is not suitable for the application demanding a random access. In other words, the CLV type has a greater storage capacity and a slower data access time.

Of course, the present invention can be applied to a speed control type that will be developed later as well as the disk speed control type, and further can be applied to all kinds of the disk speed control methods for achieving an adjustment into a predetermined revolution speed by controlling a servo gain.

For the convenience of the description of the present invention, the CLV (constant linear velocity) type is taken as a reference in the following description.

A revolution speed gain value corresponding to a predetermined revolution speed is stored in the main control unit 345.

The predetermined revolution speed is explained by taking the first and second speeds as references for the convenience of the explanation of the present invention. Yet, it is also possible to designate a plurality of revolution speeds such as a third speed, a fourth speed, and the like.

Therefore, the main control unit 345 transmits a revolution speed servo value corresponding to the first speed to the revolution speed servo control unit 331 of the servo control unit 330. The revolution speed servo control unit 331 then revolves a spindle motor 355 to correspond to the revolution speed servo value transmitted from the main control unit 345.

Moreover, the main control unit 345 corresponds to the external environmental variables to set up the values of the feeding servo gain, tracking servo gain, and focusing servo gain. The servo values of the feeding servo control, tracking servo control, and focusing servo control may be changed to correspond to the changed revolution speed, or the gain of the feeding servo or the like may be set up independently.

Relating to noises, a revolution speed of a sled motor, i.e. a revolution speed of a pickup device, can be changed into a low speed only while the revolution speed of the spindle motor is fixed to the second speed.

Namely, once the revolution speed of the disk is determined by the information inputted through the sensing unit 350 or the user interface 340, the main control unit 345 corresponds to the revolution speed or transmits another feeding servo control gain value, tracking servo control gain value, and focusing servo control gain value to the feeding servo control unit 333, tracking servo control unit 335, and focusing servo control unit 337, respectively.

Once the feeding servo control unit 333 drives a sled 325 by corresponding to the feeding servo control gain value received from the main control unit 345, the pickup device 310 moves by a speed corresponding to the servo gain value.

Once the tracking servo control unit 335 drives the sled 325 by corresponding to the tracking servo control gain value received from the main control unit 345, the pickup device 310 moves right to left by a speed corresponding to the servo gain value.

Once the focusing servo control unit 337 drives the sled 325 by corresponding to the focusing servo control gain value received from the main control unit 345, the pickup device 310 moves upward and downward by a speed corresponding to the servo gain value.

The tracking servo control and the focusing servo control generate error signals proportional to the reflective intensity of radiation of a disk surface, and are performed by adjusting the servo gains to correspond to the error signals.

FIG. 3B illustrates a flowchart of a process for controlling a gain of a servo to correspond to peripheral environmental variables according to the preferred embodiment of the present invention.

In the following description, a method of controlling a revolution speed of a disk to correspond to peripheral environmental variables according to the present invention is explained by referring to FIG. 3B in which numerals of the drawing are the same of FIG. 3A.

In a step 350, it is assumed that the disk player is being driven by the second speed at a play mode and that speeds of feeding, tracking, and the like are high speeds corresponding to the second speed.

In a step 360, the main control unit 345 enables to receive the information for external environmental variables from the sensing unit 350. It is a matter of course that the main control unit 345 may receive the information for the revolution speed through the user interface 340 as well.

The sensing unit 200 carries out a function of measuring variables for peripheral environment, and may include a power capacity measuring unit, a peripheral noise measuring unit, a temperature measuring unit, and the like.

In a step 370, the main control unit 345 judges whether a measured remaining amount of a battery exceeds a predetermined reference voltage or not. The measurement of the remaining amount of the battery is carried out by the power capacity measuring unit.

The power capacity measuring unit 203 uniformly enables to measure the capacity of the power source for real time or a predetermined period. There are various methods for measuring the capacity of the power source. And, it is a matter of course that the capacity can be measured by current as well as voltage.

As a result of the judgment, if the remaining amount of the battery is below the predetermined reference, the servo control unit preferably adjusts the gain in a step 381 to make the disk revolve by the first speed.

As a result of the judgment, if the remaining amount of the battery exceeds the predetermined reference, move to a step 373.

In the step 373, the main control unit 345 judges whether the noise of the environment in which the disk player operates exceeds the predetermined reference or not.

The measurement of the peripheral noise is carried out by the peripheral noise measuring unit 207. The peripheral noise measuring unit 207 senses a noise of a periphery and changes the sensed noise into an electrical signal to transfer to the servo control unit.

As a result of the judgment, if the peripheral noise is below the predetermined reference, the servo control unit preferably adjusts the gain in the step 381 to make the disk revolve by the first speed.

As a result of the judgment, if the peripheral noise exceeds the predetermined reference, move to a step 375.

In the step 375, the main control unit 345 judges whether the temperature at which the disk player operates is within a predetermined operating temperature range or not.

The temperature measurement is carried out by the temperature measuring unit 209. The temperature measuring unit 209 measures the peripheral temperature at which the disk player operates, and changes the temperature information into an electrical signal to transfer to the servo control unit.

As a result of the judgment, if the measured temperature fails to be within the predetermined operating temperature range, the servo control unit preferably adjusts the gain in the step 381 to make the disk revolve by the first speed.

As a result of the judgment, if the measured temperature is within the predetermined operating temperature range, move to a step 377.

Hence, if the measured voltage received through the sensing unit 350 is smaller than the predetermined voltage, if the measured noise is below the predetermined reference, or if the external measured temperature is deviated from the predetermined operating temperature, the main control unit 345 changes the driving speed of the disk player into the first speed.

Even though above-explanation is described by taking the battery remaining amount, noise, and temperature of the external environmental variables as references, it is a matter of course that other environmental variables can be added thereto.

As the disk player is driven by the second speed in the initial state, the servo control unit 330 does not generate another driving control signal in the step 377 and 379, and the disk player keeps being driven by the second speed.

In a step 381, the main control unit 345 transmits the information for the gain value corresponding to the first speed to the servo control unit 330 and controls the servo by the revolution speed of the disk players, i.e. the predetermined servo gain corresponding to the first speed, thereby enabling to drive the disk player by the first speed.

FIG. 4 illustrates a block diagram of a disk player for controlling a servo according to another preferred embodiment of the present invention.

Referring to FIG. 4, a servo control apparatus in accordance with peripheral environmental variables according to the present invention includes a disk 400, a pickup device 410, a radiation intensity detecting unit 420, a transforming unit 430, an error detecting unit 440, a main control unit 450, a servo control unit 460, an environmental variable inputting unit 470, a motor 469, a sled 467, and the like.

The main control unit 450 sets up a servo gain according to a predetermined reference by taking a signal inputted from the sensing unit 471 as a reference. Once the information for the setup gain is outputted to the servo control unit 460, the servo control unit 460 carries out controls for a feeding servo, a revolution speed servo, a tracking servo, a focusing servo, and the like according to the inputted gains. Moreover, the main control unit 450 may receive the information for a driving speed from a user through a user interface 473 instead of the sensing unit 471.

The servo control unit 460 includes a focusing servo control unit 461, a tracking servo control unit 462, a feeding servo control unit 463, and a revolution speed servo control unit 464.

The main control unit 450 provides the servo control unit 460 with an output signal of the sensing unit 471 or the user interface 473.

For instance, when environment is quiet, the main control unit 450 can provide the servo control unit 460 with control signals making a feeding speed maintain low speed and making the rest servo controls maintain their original speeds.

Moreover, if a remaining amount of a battery is below the predetermined reference value, the main control unit 450 may provide the servo control unit 460 with control signals making a disk revolution speed and a feeding speed maintain low speed and making the rest servo controls maintain their original speeds.

Of course, it is apparent to those skilled in the art that whether to change the speed of any control unit according to peripheral environmental variables can be variously modified in accordance with the setup.

The revolution speed servo control unit 464 controls a speed of a spindle motor, thereby enabling to control a revolution speed of the disk.

The main control unit 450 transmits a revolution speed servo value corresponding to the current external environment to the revolution speed servo control unit 464. The revolution speed servo control unit 464 revolves the spindle motor 469 to correspond to a revolution speed servo value transmitted from the main control unit 450.

The feeding servo control unit 463 drives the sled 467 to correspond to a feeding servo control gain value received from the main control unit 450, and the pickup device 410 moves to correspond to the received servo gain value.

The tracking servo control unit 462 drives the sled 467 to correspond to a tracking servo control gain value received from the main control unit 450, and the pickup device 410 moves right to left to correspond to a driving speed of the sled 467.

The focusing servo control unit 461 drives an actuator to correspond to a focusing servo control gain value received from the main control unit 450, and the pickup device 410 moves upward and downward to correspond to a driving speed of the actuator.

The tracking servo control and the focusing servo control generate error signals proportional to a reflective radiation intensity of a disk surface, and are achieved by adjusting the servo gains to correspond to the error signals.

The tracking servo control and the focusing servo control can be achieved by the following manner.

The pickup device 410 generally outputs one light picked by being reflected by a main beam and the other light picked up by a pair of side beams to the radiation intensity detecting unit 420. The light picked up by the main beam is used for the focusing servo, and the other light picked up by a pair of the side beams is used for the tracking servo. And, the light picked up by the main beam is outputted to a first radiation intensity detecting unit 421 and the other light picked up by a pair of the side beams is outputted to a second radiation intensity detecting unit 422.

In this case, the first radiation intensity detecting unit 421 detects a radiation intensity of the light outputted from the light pickup unit 410 as a current value to output the current value to a first current/voltage transforming unit 431, and the second radiation intensity detecting unit 422 detects a radiation intensity of the light outputted from the light pickup unit 410 as a current value to output the current value to a second current/voltage transforming unit 432.

The first current/voltage transforming unit 431 transforms the current value provided by the first radiation intensity detecting unit 421 into a voltage value to provide a focusing error detecting unit 441 with the voltage value, and the second current/voltage transforming unit 432 transforms the current value provided by the second radiation intensity detecting unit 422 into a voltage value to provide a tracking error detecting unit 442 with the voltage value.

The focusing error detecting unit 441 compares the voltage value provided by the first current/voltage transforming unit 431 and the voltage value according to the predetermined focusing error detection to each other, and outputs the comparison result, i.e. a focusing error detection signal, to the main control unit 450.

Moreover, the tracking error detecting unit 442 compares the voltage value provided by the second current/voltage transforming unit 432 and the voltage value according to the predetermined tracking error detection to each other, and outputs the comparison result, i.e. a tracking error detection signal, to the main control unit 450.

The main control unit 450 caries out a focusing servo operation according to the focusing error detection signal provided by the focusing error detecting unit 441 and the tracking error detection signal provided by the tracking error detecting unit 442 and outputs servo control signals for carrying out a tracking servo operation to the focusing and tracking servo control units 461 and 462.

In this case, the tracking servo control unit 461 carries out the focusing servo operation of adjusting the focus to the disk surface according to the servo control signal provided by the main control unit 450, and the focusing servo control unit 462 carries out the tracking servo operation of making a light beam follow the track.

Namely, the tracking servo control unit 461 drives a tracking actuator coil in accordance with a control of the main control unit 450 to move an object lens horizontally to adjust the focus to the disk surface, and the focusing servo control unit 462 drives a focusing actuator coil in accordance with a control of the main control unit 450 to adjust the object lens vertically to follow the track.

### INDUSTRIAL APPLICABILITY

The method and system for controlling the disk servo according to the present invention adjusts the gain of the servo to drive the motor and sled by slow speed if the remaining power of the power source fails to last long, thereby enabling to prevent interruption of the disk player as well as drive the disk player longer with the remaining power.

And, when the disk player is driven in a quiet place, the present invention adjusts the gain of the servo to drive the motor and sled by slow speed, thereby enabling to prevent the generation of the unnecessary noise.

Moreover, the present invention enables to carry out the above-explained control by installing a switch in the servo chipset or by the program previously inputted to the chipset.

Furthermore, the present invention enables to have the product itself judge the states of the noise, remaining power of the power source, etc. through the sensor and enables to control the disk revolution and sled driving speeds of the disk player through the user's input.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. In a servo control system of a disk player, the servo control system comprising:
a sensing unit outputting a sensing signal by monitoring at least one selected from the group consisting of an external temperature, a noise, and a remaining battery amount;
a main control unit outputting a servo gain information to respond to the sensing signal; and
a servo control unit controlling at least one of a revolution speed of a disk and a moving speed of an optical pickup to respond to the servo gain information of the main control unit.

2. The servo control system of claim 1, further comprising a user interface receiving the servo gain information from a user.

3. The servo control system of claim 1, wherein the servo control unit includes a revolution speed servo control unit, a feeding servo control unit, a tracking servo control unit or a focusing servo control unit.

4. The servo control system of claim 3, wherein the main control unit provides the servo control unit with an information for a revolution speed servo gain and wherein servo gain values of the feeding servo control unit, the tracking servo control unit, and the focusing servo control unit are set to correspond to a servo gain value of the revolution speed servo control unit.

5. The servo control system of claim 3, wherein the main control unit provides the revolution speed servo control unit, the feeding servo control unit, the tracking servo control unit, and the focusing servo control unit with a revolution speed servo gain information, a feeding servo gain information, a tracking servo gain information, and a focusing servo gain information, respectively.

6. The servo control system of claim 5, wherein the revolution speed of the disk is maintained as it is and the moving speed of the optical pickup is set by low speed if the monitored noise is below a predetermined reference.

7. In a servo control system of a disk player, the servo control system comprising:
a noise measuring unit outputting a sensing signal by monitoring a magnitude of a peripheral noise;
a main control unit outputting a servo gain information to respond to the sensing signal of the noise measuring unit; and
a servo control unit controlling at least one of a revolution speed of a disk and a moving speed of an optical pickup to respond to the servo gain information of the main control unit.

8. The servo control system of claim 7, further comprising a user interface receiving the servo gain information from a user.

9. The servo control system of claim 7, wherein the servo control unit includes a revolution speed servo control unit, a feeding servo control unit, a tracking servo control unit or a focusing servo control unit.

10. In a servo control system of a disk player, the servo control system comprising:
a remaining battery amount measuring unit outputting a sensing signal by monitoring a remaining amount of a power;
a main control unit outputting a servo gain information to respond to the sensing signal of the remaining battery amount measuring unit; and
a servo control unit controlling at least one of a revolution speed of a disk and a moving speed of an optical pickup to respond to the servo gain information of the main control unit.

11. The servo control system of claim 10, further comprising a user interface receiving the servo gain information from a user.

12. The servo control system of claim 10, wherein the servo control unit includes a revolution speed servo control unit, a feeding servo control unit, a tracking servo control unit or a focusing servo control unit.

13. In a servo control system of a disk player, the servo control system comprising:
a temperature measuring unit outputting a sensing signal by monitoring a peripheral temperature;
a main control unit outputting a servo gain information to respond to the sensing signal of the temperature measuring unit; and
a servo control unit controlling at least one of a revolution speed of a disk and a moving speed of an optical pickup to respond to the servo gain information of the main control unit.

14. The servo control system of claim 13, further comprising a user interface receiving the servo gain information from a user.

15. The servo control system of claim 13, wherein the servo control unit includes a revolution speed servo control unit, a feeding servo control unit, a tracking servo control unit or a focusing servo control unit.
